(19) United States
(12) Patent Application Publication
(10) Pub. No.: US 2022/0245425 A1
(43) Pub. Date: Aug. 4, 2022

(54) KNOWLEDGE GRAPH EMBEDDING USING GRAPH CONVOLUTIONAL NETWORKS WITH RELATION-AWARE ATTENTION

(71) Applicant: International Business Machines Corporation, Armonk, NY (US)

(72) Inventors: Nasrullah Sheikh, San Jose, CA (US); Xiao Qin, San Jose, CA (US); Berthold Reinwald, San Jose, CA (US); Christoph Adrian Miksovic Czasch, Aeugst am Albis (CH); Thomas Gschwind, Aeugst am Albis (CH); Paolo Scotton, Rueschlikon (CH)

(21) Appl. No.: 17/161,933

(22) Filed: Jan. 29, 2021

(51) Int. Cl. G06N 3/04; G06N 3/08

(52) U.S. Cl. CPC G06N 3/0427; G06N 3/08

(57) ABSTRACT

A knowledge graph embedding method, system, and computer program product using a computing device to embed a knowledge graph using a graph convolutional network, the method including learning, by the computing device, an embedding of the knowledge graph that includes entities, relations, and edges, weighing, by the computing device, initial feature vectors of nodes and a convolutional layer output to compute a weight and modifying the embedding based on the weight, and using, by the computing device, the modified embedding to perform a task related to the knowledge graph.

### CROSS REFERENCE TO RELATED APPLICATIONS

The present application is a related Application of co-pending U.S. patent application No. ______, IBM Disclosure No. P202007822US01, which was concurrently filed herewith on Jan. 29, 2021, the entire contents of which are incorporated herein by reference.

### BACKGROUND

The present invention relates generally to a knowledge graph embedding method using a graph convolutional network, and more particularly, but not by way of limitation, to a system, method, and computer program product for exploiting relations and neighborhood information in the graph convolutional network to learn importance of the neighbors.

Knowledge Graphs (KGs) represent facts in a form of entities and relations between the entities. A fact is represented by a triplet (h, r, t), where h, t represent head and tail entities respectively, and r represents the relation between h and t.

Furthermore, entities and relations may have some additional information such as attributes associated with them. Data from different domains such as enterprises, gene ontology, etc. can be modeled as KGs. Modeling the domain data as KGs is useful in different applications. KGs are critical to enterprises as they enable an organization to view, analyze, derive inferences, and build up knowledge for a competitive advantage. For example, discovering new links between entities may be useful in many scenarios such as discovering new side effects of a drug, establishing new corporate relationships, etc.

One of the biggest challenges of performing this link prediction (i.e., analyzing, drawing inferences, etc.) is to extract data from various structured and unstructured sources and build the data in a KG such that the data can be used effectively in various tasks (i.e., search and answer, entity matching, link prediction, etc.).

An example of an enterprise knowledge graph is shown in FIG. 2. The KG shows companies, subsidiaries, products, industry types, and product types represented as entities, whereas “in_industry”, “subsidiary of”, “acquired”, and “is a” epresent the relationships between the entities. Often, these KGs are sparse and have missing information. For example, in FIG. 2, the relationship between “Car Company A, Inc.” and “Automotive” is missing (<Car Company A, Inc,?, Automotive>). In general, the missing information in KGs can be of the form (h, r, ?), (?, r, t), and/or (h, ?, t).

Conventional techniques have been proposed which learn e beddings of entities and relationships, and use a scoring function to determine if a triplet (h, r, t) is valid or not. These conventional models process each triplet independent of other triplets, and hence do not exploit the neighborhood information in learning. Graph convolution-based techniques overcome this problem by aggregating the features from the neighboring entities and applying a transformation function to compute the new features. However, these graph-based techniques give equal weights to each of the neighboring entities, thereby ignoring that the neighbors have different significance in computing new features. This attention mechanism considers edges having the same type. Thus, it cannot be directly extended to knowledge graphs which have multiple relation-types between entities

### SUMMARY

In a knowledge graph, relation-types between entities determine the semantics of an edge. This semantic information is crucial in various downstream tasks such as link prediction and entity matching. Therefore, the relationship-types cannot be ignored in computing the importance of neighbors. Towards this end, the inventors have recognized a problem and have invented a technical solution by inventing a relation-aware masked attention mechanism in knowledge graphs, which includes the features of relation for computing the attention. This attention is applied to the messages from neighbors during the propagation phase of graph neural networks (GNNs) to learn the embedding of entities and relations. The learning is optimized through a scoring function, which may score a valid triplet higher than an invalid triplet, based on the representation of entities and relations. Moreover, the proposed technical solution is inductive (i.e., the learned model can be used to infer embeddings of unseen nodes).

Thereby, a practical application is obtained via the technical solution disclosed herein in that entities are linked to another similar entity in a knowledge graph, such that a company can better populate the knowledge graph and increase potential sales based on the new links. Also, the technical solution can be implemented with a query graph for matching using the new links.

In an exemplary embodiment, the present invention can provide a computer- implemented knowledge graph embedding method using a computing device to embed a knowledge graph using a graph convolutional network, the method including learning, by the computing device, an embedding of the knowledge graph that includes entities, relations, and edges, weighing, by the computing device, initial feature vectors of nodes and a convolutional layer output to compute a weight and modifying the embedding based on the weight, and using, by the computing device, the modified embedding to perform a task related to the knowledge graph.

In a second exemplary embodiment, the present invention can provide a computer program product for knowledge graph embedding that embeds a knowledge graph using a graph convolutional network, the computer program product comprising a computer-readable storage medium having program instructions embodied therewith, the program instructions executable by a computer to cause the computer to perform learning an embedding of the knowledge graph that includes entities, relations, and edges, weighing initial feature vectors of nodes and a convolutional layer output to compute a weight and modifying the embedding based on the weight, and using the modified embedding to perform a task related to the knowledge graph.

In a third exemplary embodiment, the present invention can provide a knowledge graph embedding system that embeds a knowledge graph using a graph convolutional network, said system including a processor and a memory, the memory storing instructions to cause the processor to perform learning an embedding of the knowledge graph that includes entities, relations, and edges, weighing initial feature vectors of nodes and a convolutional layer output to compute a weight and modifying the embedding based on the weight, and using the modified embedding to perform a task related to the knowledge graph.

In another exemplary embodiment, attribute information of the nodes and structural information of the nodes are exploited to learn the embeddings of the entities and the relations, the learning utilizing a model that includes an attribute embedding layer and a convolutional layer, the attribute embedding layer encodes different sets of attributes of the entities and projects the different sets of attributes in a same d-dimensional space, and an output of the attribute layer is an initial feature vector of the entities.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a knowledge graph embedding method 100;

FIG. 2 exemplarily depicts an example of an enterprise Knowledge Graph (KG) having three entity types and five link types while illustrating missing link information;

FIG. 3 exemplarily depicts a practical application of a query graph being used to find a matching entity in a reference graph;

FIG. 4 exemplarily depicts an attention mechanism of the invention;

FIG. 5 depicts a cloud computing node 10 according to an embodiment of the present invention;

FIG. 6 depicts a cloud computing environment 50 according to an embodiment of the present invention; and

FIG. 7 depicts abstraction model layers according to an embodiment of the present invention.

### DETAILED DESCRIPTION

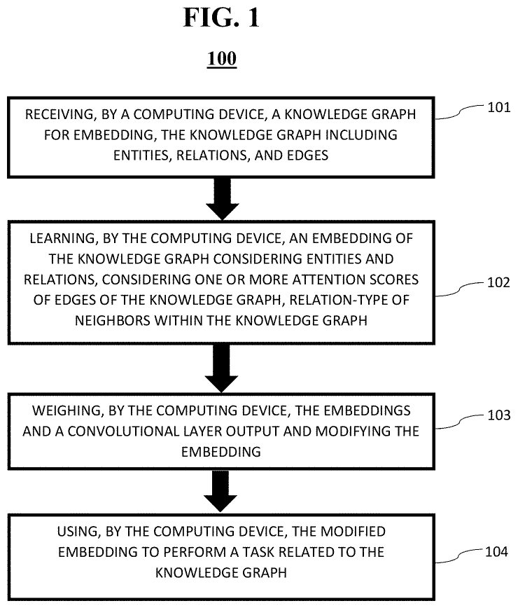

The invention will now be described with reference to FIG. 1-7, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the example depicted in FIG. 1, the knowledge graph embedding method 100 includes various steps for a relation-aware graph attention model that leverages relation information to compute different weights to the neighboring nodes for learning an embedding of entities and relations.

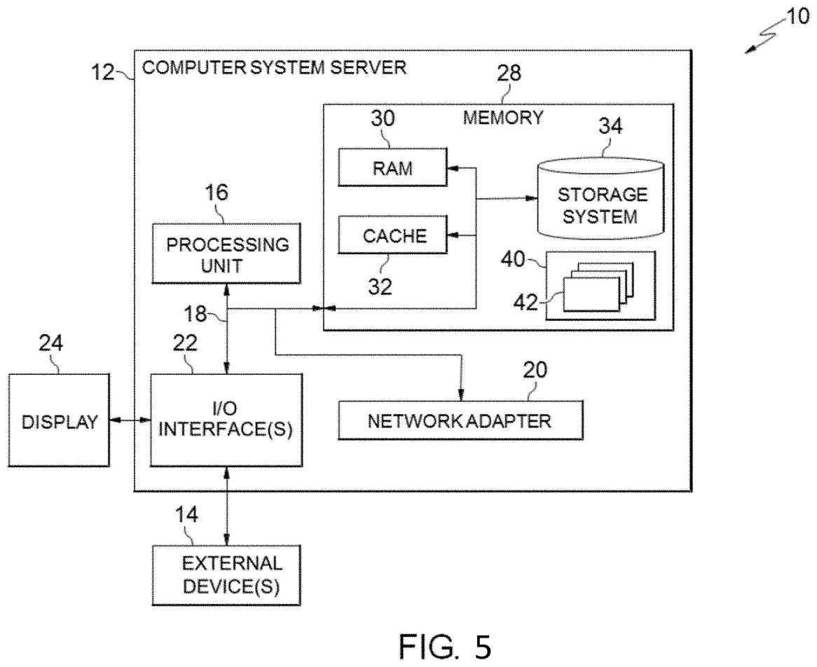

As shown in at least FIG. 5, one or more computers of a computer system 12 according to an embodiment of the present invention can include a memory 28 having instructions stored in a storage system to perform the steps of FIG. 1.

Thus, the knowledge graph embedding method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties --- perception, goal-oriented behavior, learning/memory and action---that characterize systems (i.e., humans) generally recognized as cognitive.

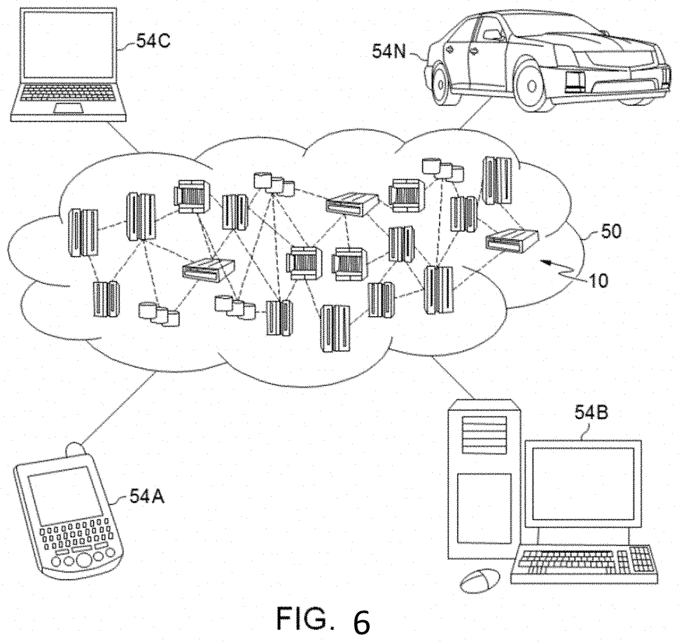

Although one or more embodiments (see e.g., FIGS. 5-7) may be implemented in a cloud environment 50 (see e.g., FIG. 6), it is nonetheless understood that the present invention can be implemented outside of the cloud environment.

With reference generally to FIGS. 1-4, for each node, a message passing Graph Neural Network (GNN) iteratively aggregates representation from its neighbors. Each iteration defines a layer of GNN, and I iterations (layers) encode the structural information of the graph within its l□hop neighborhood. The l□th layer of a GNN is described as:

α_{υ}_{ᵢ}^{(l+1)}=Agg ({hᵤ⁽¹⁾|u∈N(υᵢ)}), (1)

where h_{υ}_{₁}^{(l+1)} is the vector representation of the node vᵢ at the i□th iteration. The N(.) function returns neighbors of a node, and Agg is an aggregation function which is defined as per the modelling approaches of different methods

Based on the above premise, the invention uses a relation-aware attention model that exploits a relation between two entities to learn an importance of neighboring nodes, which gives weights to the features received from neighbors according to their importance, and then recursively propagates node features in the graph. The inventive model has two components: (1) an embedding layer and (2) a knowledge graph convolutional layer with relation-aware attention.

For the embedding layer, additional information such as attributes associated with entities in the KG contain semantic information. Therefore, this information can be leveraged in learning. For each entity, the method 100 concatenates the various textual attributes and uses a pre-trained model (i.e., a BERT model that may be used as a preprocessing step to obtain a unified features from various textual attributes) to obtain their embeddings. These embeddings form an initial feature vector of entities to be used in the training. In the case of datasets which do not have attributes, the embedding layer is initialized randomly.

The invention lies within the second component, the knowledge graph convolutional layer with relation-aware attention.

This layer is defined as a single neural network layer which performs relation-aware attention, feature propagation, and aggregation. The input to this layer is a set of N node features from embedding layer h={hᵢ, h₂,···, h,_{N}}where hᵢ ∈R^{r} represents the d□dimensional features of i^{th} node; a set of relation-types R={r₁r₂, ···,rₖ}; and a set of relation features m={m₁,m₂,···mₖ} where mᵣ∈R^{d} is the feature vector of r^{th}□relation-type of dimension d.

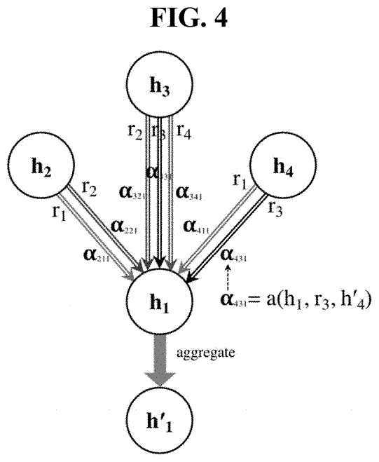

For relation-aware attention, in a Knowledge Graph, nodes have different types of relationships. Thus, the importance of neighbors is not only dependent on their features, but also on the features of the relationships. To this end, the invention applies a. shared linear transformation on triplets (h, r, t), parameterized by a weight matrix W. Then, self-attention is performed with respect to a shared relation between entities to compute attention coefficients: α: R^{d} ×R^{d} ×R^{d}→R. The attention mechanism is shown in FIG. 4. The attention coefficient of a triplet (h, r, t) is computed as:

e_{(n,r,t)}=α(Whₕ,Wmᵣ, Wh) (2)

The attention mechanism a is a trainable function parameterized by a weight vector a ∈R^{3d}, which is given as:

e_{(h,r,t)}=a^{T}[Whₕ∥Wmᵣ∥Whₜ] (3)

where T and ∥are transpose and concatenation operations, respectively. Moreover, the attention is masked (i.e., the attention is computed for directly-connected neighbors only given by Nₕ). The invention applies soffinax to make attention coefficients comparable across the neighborhood, as given in Eq. (4).

$${α}_{( h , r , t )} = softmax ( {e}_{( h , r , t )} ) = \frac{exp {(}_{( h , r , t )} )}{{Σ}_{( {r}^{′} , {t}^{′} ) ∈ {N}_{h}} exp ( {e}_{( h , {r}^{′} , {t}^{′} )} )} \qquad ( 4 )$$

For feature propagation and aggregation, knowledge graph convolutional network architectures consider the heterogeneity of the edges and use a message passing framework to compute a new representation of a head node by applying some relation-specific transformation on representation of neighbors before aggregating at the head node. Following Eq. (1), a generalized framework for knowledge graphs can be expressed as:

hₙ^{′}=σ(Agg(_{(y,f)∈N}_{ₕ}f(hₕ,r,hₜ)) (5)

where f is a relation-specific transfoiiiiation on representation of immediate neighborhood nodes given by Nₕ, Agg is an aggregator function such as SUM, MEAN that combines these transformed messages from its neighbors before passing it to an activation function ( ), and hₙ^{′}is the new hidden features of entity h.

Combining Equation (5) and Equation (4) describes a single neural layer for knowledge graph convolution with relation-aware attention.

=σ(Agg_{(r,t)∈N}_{ₕ}α(h,r,t)f(h_{h,},r,hₜ)) (6)

Equation 6 is agnostic to the underlying knowledge graph convolution message passing paradigm. Equation 6 is extended to L□layers as Equation 7:

$${h}_{h}^{( l + 1 )} = σ ( {\sum }_{r ∈ R} {\sum }_{t ∈ {𝒩}_{h}^{r}} {α}_{( h , r , t )} \frac{1}{{𝒩}_{h}^{r}} {W}_{r}^{( l )} {h}_{t}^{( l )} + {W}_{0}^{( l )} {h}_{h}^{( l )} ) \qquad ( 7 )$$

where Wᵣ^{(l)}is the weight matrix corresponding to relation r in l-th□layer, and Nₕ^{r} gives the set of neighbors which share relation r with entity h.

The objective of the knowledge graph-based embedding methods is to learn embeddings of entities and relations which are input to a scalar output producing scoring function (g) which scores true triplets much higher (i.e., the scores are between [0,1] and a higher score represents a score with respect to the scores of other triplets) than false triplets.

Method 100 given above is limited to use only scoring functions which describe relation in R^{d} space. Therefore, a scoring function given as equation (8) is used:

g(h,r,t)=hₕ^{T}Mᵣhₜ(8)

The model is trained using a negative sampling approach. For each positive triplet τ∈T+, a set of negative samples is generated by either corrupting h or t which produces a set of negative triplets T⁻. Given the set of positive and negative triplets T =T⁺∪T⁻, the model optimizes on cross entropy loss so as to learn entity and relation embeddings, as shown in Equation 9.

$$L = \frac{1}{\vert T \vert} {Σ}_{τ ∈ T} y log l ( g ( τ ) ) + ( 1 - y ) log ( 1 - l ( g ( τ ) ) ) \qquad ( 9 )$$

where τis training example (h, r, t) ; l is logistic sigmoid function; y is 1 or 0 for positive or negative triplet, respectively,

Thereby, the method disclosed above includes a relation-aware masked attention mechanism that leverages the relation and neighborhood information to compute the importance of neighbors. Using this attention, the features are propagated from the neighbors of an entity to update its embedding.

With reference hack to FIG. 1, in step 101, a knowledge graph is received (or otherwise available for use) for embedding, the knowledge graph including entities, relations, and edges. Edges are formed with entities and the relations between them. The attribute information of nodes is used, if present.

In step 102, an embedding of the knowledge graph is learned by considering entities and relations and considering one or more attention scores of edges of the knowledge graph, and relation-type of neighbors within the knowledge graph.

In step 103, the embeddings and a convolutional layer output are weighed and the embedding is modified based on a result of the weighing. The weight is computed between the information received from the convolutional layer and the initial features, and this attention score is used to combine these two features. Step 103 emphasizes that the features obtained from convolutional and initial features have different importance based on a context. Thus, the self- attention mechanism is applied to learn the weight for combining these two features.

Indeed, in step 103, the initial feature vector of nodes and the convolutional layer output are weighed to compute the final embedding of nodes.

In step 104, the modified embedding are used to perform a task related to the knowledge graph. That is, in step 104, the learned embeddings are used in downstream machine learning tasks such as link prediction, entity matching, etc.

The method 100 is therefore able to learn generic embeddings of entities and relations in an unsupervised manner which then can be used in various downstream machine learning tasks.

Indeed, the method 100 exploits the attribute information and structural information to learn the embeddings of entities and relations. The model specifically includes two neural network layers: the attribute embedding layer, and the convolutional layer. The attribute embedding layer encodes the various different sets of attributes of entities and projects them in the same d-dimensional space. The output of the attribute layer becomes the initial feature vector of entities. This initial feature vector is used in the convolutional layer which aggregates these feature vectors of neighbors. The aggregation is a weighted aggregation and this weight is calculated using the features of neighbors and the features of the links connecting them.

Moreover, to balance the importance of the attribute features and the topological features for the relationship prediction, the method employs a self-attention mechanism to combine the attribute embedding and the output of the convolutional layer to obtain the final embedding. This final embedding is used to determine the validity of the triplet.

Thus, the graph neural network-based method 100 uses the relation in determining the weights of the neighbors to learn the embeddings of entities and relationships. The method incorporates a self-attention mechanism to balance the attribute embedding and learned embedding. The embedding of entities and relations are used to determine the validity of the triplet by training on a set of positive and negative triplets. The valid triplets are scored higher than the invalid triplets. Tests of the method 100 on two public datasets and one proprietary dataset show that the inventive method 100 achieves an average improvement of 2.8% in Mean Reciprocal Rank (MRR) on a link prediction task. Moreover, the method achieved around 5% increase in entity matching task against using only the feature vectors of entities for matching.

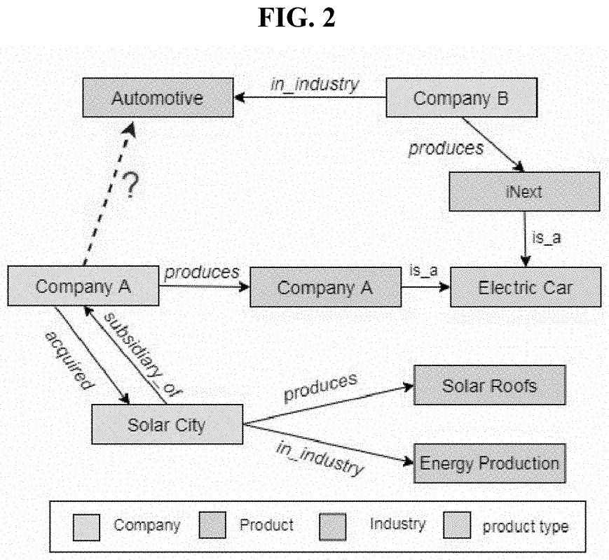

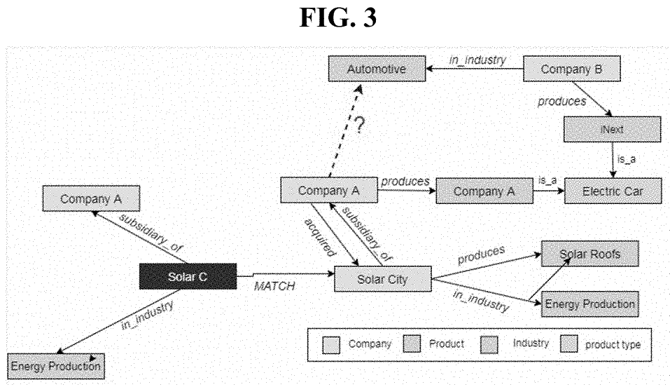

With reference to FIGS. 2-3, the method 100 can be used for link prediction, entity matching, etc. In case of a company knowledge graph, sales team can use link prediction to identify the companies to target the product sales.

The companies receive information from various sources which are often incomplete. This entities in this new information (query graph) need to be mapped to an existing knowledge graph so as to gather more insights. The inventive model enables to find a matching entity for query entity in knowledge graph.

Exemplars Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can he rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e- mail). The consumer does not manage or control the underlying cloud infrastructure including network, servers, operating systems, storage, or even individual application capabilities, with the possible exception of limited user-specific application configuration settings,

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services,

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systeiiis, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits. Referring again to FIG. 5, computer system/server 12 is shown in the form of a general-purpose computing circuit. The components of computer system/server 12 may include, but are not limited to, one or more processors or processing units 16, a systeiii memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 6, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A- N shown in FIG. 6 are intended to be illustrative only and that computing nodes 10 and cloud computing environment 50 can communicate with any type of computerized circuit over any type of network and/or network addressable connection (e.g., using a web browser).

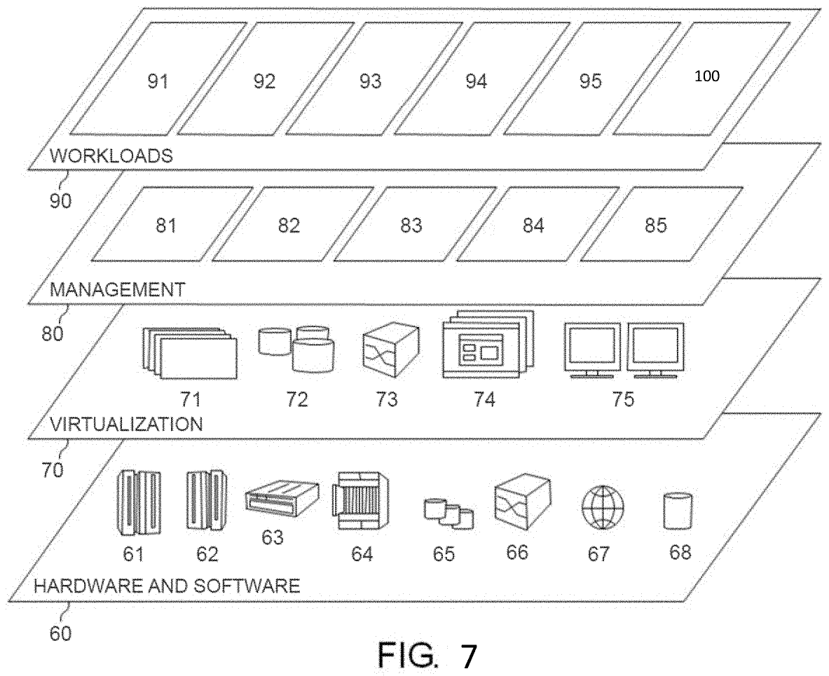

Referring now to FIG. 7, an exemplary set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the knowledge graph embedding method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire,

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry,in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented knowledge graph embedding method using a computing device to embed a knowledge graph using a graph convolutional network, the method comprising:
learning, by the computing device, an embedding of the knowledge graph that includes entities, relations, and edges;
weighing, by the computing device, initial feature vectors of nodes and a convolutional layer output to compute a weight and modifying the embedding based on the weight; and
using, by the computing device, the modified embedding to perform a task related to the knowledge graph.

2. The computer-implemented method of claim 1 wherein, prior to the weighing, the features of neighbors and their relations are used to compute the weight which is applied to the features in convolutional layer.

3. The computer-implemented method of claim 1, wherein the embedding of the knowledge graph considers:
the entities and the relations therebetween;
one or more attention scores of the edges of the knowledge graph; and
a relation-type of neighbors within the knowledge graph.

4. The computer-implemented method of claim 1, wherein the edges are formed with the entities and the relations between the entities, and
wherein attribute information of nodes is used if available.

5. The computer-implemented method of claim 1, wherein the weight is computed between the embedding produced from the convolutional layer and the initial feature vectors, and
wherein an attention score is used to combine the embedding produced from the convolutional layer and the initial feature vectors.

6. The computer-implemented method of claim 5, wherein the weighing is used to emphasize that the features obtained from the convolutional layer and the initial feature vectors that have a different importance based on a context.

7. The computer-implemented method of claim 1, wherein attribute information of the nodes and structural information of the nodes are exploited to learn the embeddings of the entities and the relations,
wherein the learning utilizes a model that includes an attribute embedding layer and a convolutional layer, the attribute embedding layer encodes different sets of attributes of the entities and projects the different sets of attributes in a same d-dimensional space, and
wherein an output of the attribute layer is an initial feature vector of the entities.

8. The computer-implemented method of claim 7, wherein the initial feature vector is used in the convolutional layer which aggregates feature vectors of the neighbors, the aggregation being a weighted aggregation performed by the weighing,
wherein the weight is calculated using the features of neighbors and the features of the links connecting them.

9. The computer-implemented method of claim 1, embodied in a cloud-computing environment.

10. A computer program product for knowledge graph embedding that embeds a knowledge graph using a graph convolutional network, the computer program product comprising a computer-readable storage medium having program instructions embodied therewith, the program instructions executable by a computer to cause the computer to perform:
learning an embedding of the knowledge graph that includes entities, relations, and edges;
weighing initial feature vectors of nodes and a convolutional layer output to compute a weight and modifying the embedding based on the weight; and
using the modified embedding to perform a task related to the knowledge graph.

11. The computer program product of claim 10, wherein, prior to the weighing, the features of neighbors and their relations are used to compute the weight which is applied to the features in convolutional layer.

12. The computer program product of claim 10, wherein the embedding of the knowledge graph considers:
entities and relations there between;
one or more attention scores of edges of the knowledge graph; and
a relation-type of neighbors within the knowledge graph.

13. The computer program product of claim 11, wherein the edges are formed with the entities and the relations between the entities, and
wherein attribute information of nodes is used if available.

14. The computer program product of claim 10, wherein the weight is computed between the embedding produced from the convolutional layer and the initial feature vectors, and wherein an attention score is used to combine the embedding produced from the convolutional layer and the initial feature vectors.

15. The computer program product of claim 14, wherein the weighing is used to emphasize that the features obtained from the convolutional layer and the initial features have different importance based on a context.

16. The computer program product of claim 10, wherein attribute information of the nodes and structural information of the nodes are exploited to learn the embeddings of the entities and the relations,
wherein the learning utilizes a model that includes an attribute embedding layer and a convolutional layer, the attribute embedding layer encodes different sets of attributes of the entities and projects the different sets of attributes in a same d-dimensional space, and
wherein an output of the attribute layer is an initial feature vector of the entities.

17. The computer program product of claim 16, wherein the initial feature vector is used in the convolutional layer which aggregates feature vectors of the neighbors, the aggregation being a weighted aggregation performed by the weighing,
wherein the weight is calculated using the features of neighbors and the features of the links connecting them.

18. The computer program product of claim 10, embodied in a cloud-computing environment.

19. A knowledge graph embedding system that embeds a knowledge graph using a graph convolutional network, said system comprising:
a processor; and
a memory, the memory storing instructions to cause the processor to perform:
learning an embedding of the knowledge graph that includes entities, relations, and edges;
weighing initial feature vectors of nodes and a convolutional layer output to compute a weight and modifying the embedding based on the weight; and
using the modified embedding to perform a task related to the knowledge graph.

20. The system of claim 19, embodied in a cloud-computing environment.
